(19) United States
(12) Patent Application Publication
(10) Pub. No.: US 2010/0323666 A1
(43) Pub. Date: Dec. 23, 2010

(54) SEQUENTIAL MESSAGE DELIVERY FOR FDA PROCESSING AND STORE-AND-FORWARD PROCESSING

(76) Inventors: Yigang Cai, Naperville, IL (US); Alan Curtis, Granville, OH (US); Shaumir Shah, Aurora, IL (US); Gyan Shanker, Naperville, IL (US)

Correspondence Address: DUFT BORNSEN & FISHMAN, LLP, 1526 SPRUCE STREET, SUITE 302, BOULDER, CO, 80302, US

(21) Appl. No.: 12/489,994

(22) Filed: Jun. 23, 2009

(51) Int. Cl. H04L 12/58; H04W 4/00

(52) U.S. Cl. 455/412.1; 455/466

(57) ABSTRACT

Systems and methods are disclosed for delivering text messages using both First Delivery Attempt (FDA) processing and store-and-forward processing. A message system in one embodiment includes a message processor that receives a text message intended for a destination, and determines whether a prior text message is pending in a store-and-forward system for the destination. If a prior text message is not pending, then the message processor forwards the received text message to a FDA system for FDA processing. If a prior text message is pending, then the message processor forwards the received text message to the store-and-forward system for store-and-forward processing. The store-and-forward system will deliver the prior text message to the destination before the received text message so that the text messages are delivered in the proper sequence.

### BACKGROUND

1. Field of the Invention

The invention is related to the field of communications and, in particular, to delivery of text messages.

2. Statement of the Problem

In many mobile networks, text messaging has become a very popular mode of communication. One example of text messaging is Short Message Service (SMS), which is a communication protocol allowing the exchange of short text messages (i.e., 160 characters) between mobile devices. Often times, mobile users more frequently use text messaging for communication than voice calls.

Text messages are transmitted over signaling channels of a mobile network, such as over SS7 channels. An SMS Center (SMSC) in the mobile network has a store-and-forward system for delivering text messages to their destinations over the signaling channels. Upon initially receiving a text message, the store-and-forward system first stores (persistently) the text message, and then initiates a delivery attempt for the text message. If the first delivery attempt is unsuccessful, then the store-and-forward system enters a retry process. For the retry process, the store-and-forward system will retry delivery a predefined number of times before the text message is discarded.

The following illustrates an example of delivering a text message from an originating mobile device to a destination mobile device in a UMTS network. To start, a sender originates the text message through the originating mobile device, and the originating mobile device sends the text message to an SMSC. A store-and-forward system in the SMSC receives and stores the text message. The store-and-forward system then queries a Home Location Register (HLR) to identify routing information for the text message. The HLR responds to the query with the routing information, and the store-and-forward system then attempts to forward the text message to the destination mobile device based on the routing information. If the first delivery attempt is unsuccessful, then the store-and-forward system retries delivery after a time period. The store-and-forward system will retry delivery a predefined number of times before the text message is discarded.

The store-and-forward approach to text messaging drives up the cost of the SMSC due to the expensive storage subsystems used for storing the text messages before delivery. As the volume of text messages increases in mobile networks, the unit price per text message drops significantly. Thus, profit margins for text messaging have become lower for the network operators. To reduce costs and increase network capability for delivering text messages, some network operators no longer use only store-and-forward processing. Instead, many network operators offer an alternative approach, which is referred to as First Delivery Attempt (FDA) processing. With FDA processing, delivery of a text message to the destination is attempted before it is stored. If delivery fails, then the text message is stored, and normal store-and-forward processing occurs.

The following illustrates an example of FDA processing used to deliver a text message in a UMTS network. The sender originates the text message through an originating mobile device, and the originating mobile device sends the text message to an FDA system. The FDA system initially receives the text message, and queries the HLR to identify routing information for the text message. The HLR responds to the query with the routing information, and the FDA system then attempts to forward the text message to the destination mobile device based on the routing information, without first persistently storing the text message in memory. If the FDA system determines that delivery of the text message failed, then the FDA system routes the text message to the SMSC. The store-and-forward system in the SMSC then stores the text message, and attempts delivery of the text message according to store-and-forward processing.

One problem encountered when both FDA processing and store-and-forward processing are used to deliver text messages to the same destination is that the text messages may be sent out of sequence. For example, assume that a sender originates a first text message to a destination. The FDA system receives the first text message, and attempts to forward the first text message to the destination (without first persistently storing the first text message in memory). If the FDA system determines that delivery of the first text message has failed, then the FDA system routes the text message to the SMSC. The store-and-forward system in the SMSC then stores the first text message (which is also referred to as queuing the first text message for a later delivery), and attempts to deliver the first text message to the destination based on store-and-forward processing.

Assume further that the sender originates a second text message to the same destination. The FDA system receives the second text message, and attempts to forward the second text message to the destination (without first persistently storing the second text message in memory). If the destination is available to receive the second text message and the FDA system delivers the second text message while the first text message is still queued in the store-and-forward system, then the destination will receive the second text message before the first text message. The text messages are unfortunately received out of sequence, which can be confusing to the destination of the text messages.

### SUMMARY

Embodiments described herein are able to provide text messages to a destination in the proper sequence when FDA processing and store-and-forward processing are used to deliver the text messages. When a text message is received and before FDA processing is performed, a determination is made as to whether a prior text message is pending in a store-and-forward system for the same destination. If a prior text message is not pending, then the received text message is forwarded to the FDA system for FDA processing. However, if a prior text message is pending, then the received text message is forwarded to the store-and-forward system for store-and-forward processing. Thus, the received text message will be queued for delivery behind the prior text message in the store-and-forward system, and the prior text message will be delivered first to the destination. The destination will advantageously receive the text messages in the proper sequence.

One embodiment comprises a message system operable to handle text messages in a mobile network. The message system includes a message processor operable to receive a text message intended for a destination, and to determine whether a prior text message is pending in a store-and-forward system for the destination. If a prior text message is not pending in the store-and-forward system, then the message processor is further operable to forward the received text message to an FDA system for FDA processing. If a prior text message is pending in the store-and-forward system, then the message processor is further operable to forward the received text message to the store-and-forward system for store-and-forward processing. The store-and-forward system will deliver the prior text message to the destination before the received text message so that the text messages are delivered in the proper sequence.

In another embodiment, the message system includes a central database operable to store message indicators for a plurality of destinations. The message indicator indicates whether a prior text message is pending in the store-and-forward system for a destination. The central database is updated by the store-and-forward system. For example, the store-and-forward system is operable to detect the prior text message that is pending for the destination, to generate a first update message indicating that the prior text message is pending for the destination, and to transmit the first update message to the central database. The central database is operable to receive the first update message from the store-and-forward system, and to update the message indicator for the destination based on the first update message. The store-and-forward system is further operable to detect a successful delivery of the prior text message to the destination, to generate a second update message indicating that the prior text message was successfully delivered to the destination, and to transmit the second update message to the central database. The central database is operable to receive the second update message from the store-and-forward system, and to update the message indicator for the destination based on the second update message.

With the central database updated by the store-and-forward system, the message processor may query the central database for the message indicator of a particular destination. As an example, the message processor is further operable to transmit a query to the central database as to whether a prior text message is pending in the store-and-forward system for the destination. The central database is further operable to receive the query, to process the query to identify a destination ID for the destination, to search for a message indicator that is mapped to the destination based on the destination ID, and to transmit a response that includes the message indicator mapped to the destination. The message processor is further operable to process the message indicator in the response to determine whether a prior text message is pending in the store-and-forward system for the destination.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a mobile network in an exemplary embodiment.

FIG. 2 is a flow chart illustrating a method of controlling FDA processing and store-and-forward processing for text messages in an exemplary embodiment.

FIG. 3 illustrates a table that maps message indicators to destinations in an exemplary embodiment.

FIGS. 4-5 are flow charts illustrating a method of querying a central database for a message indicator in an exemplary embodiment.

FIGS. 6-8 are flow charts illustrating a method of updating a central database in an exemplary embodiment.

FIG. 9 illustrates an IMS network in an exemplary embodiment.

FIGS. 10-11 are message diagrams illustrating how a message processor ensures that an SMS message is delivered in the proper sequence in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

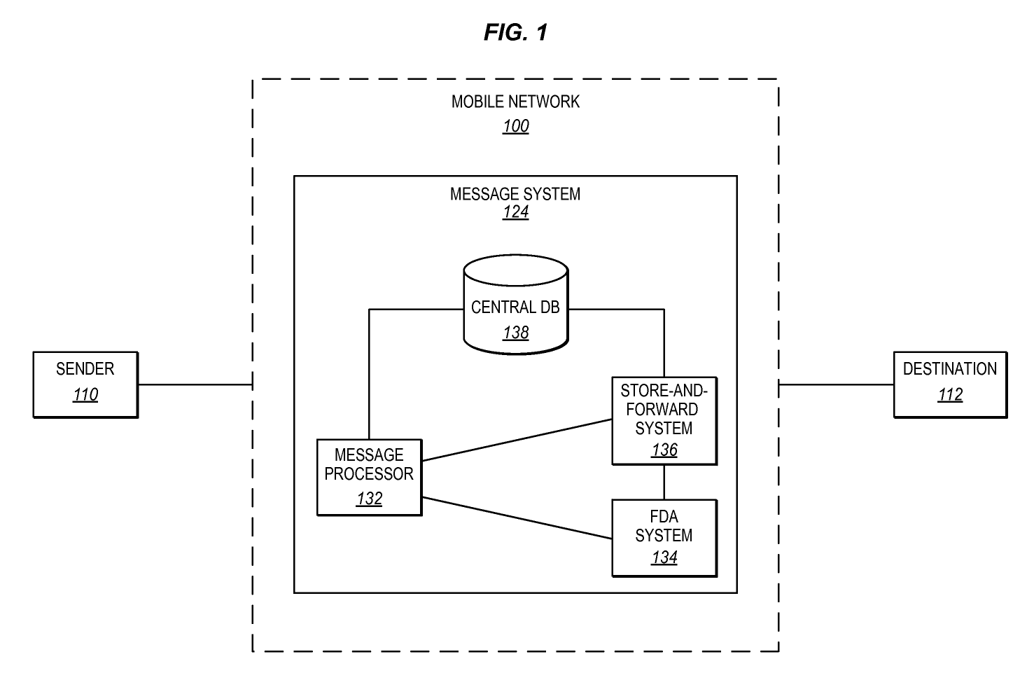

FIG. 1 illustrates a mobile network 100 in an exemplary embodiment. Mobile network 100 may comprise a circuit-based network, such as a CDMA network or a GSM network, may comprise a packet-based network, such as an IP Multimedia Subsystem (IMS) network, or a mix of the two. Mobile network 100 is able to facilitate the transfer of a text message from a sender 110 to a destination 112. Because sender 110 and destination 112 may be served by different networks, mobile network 100 may represent an “originating” network for a Mobile Originating (MO) scenario, or may represent a “terminating” network for a Mobile Terminating (MT) scenario.

In this embodiment, mobile network 100 includes a message system 124, which comprises any system, server, or function operable to handle text messages. Message system 124 includes a message processor 132, a First Delivery Attempt (FDA) system 134, a store-and-forward system 136, and a central database 138. Message processor 132 comprises any device, component, system, or application operable to control whether FDA processing or store-and-forward processing is applied to a text message. Message processor 132 controls the application of FDA processing or store-and-forward processing to a text message based on whether one or more prior text messages are pending in store-and-forward system 136 for the same destination. As a result, message processor 132 is able to ensure that text messages are received at a destination in the proper (time) sequence.

FDA system 134 comprises any system, server, application, or function operable to implement FDA processing. In FDA processing, when a text message is initially received, delivery of the text message is attempted first before storing the text message. Those skilled in the art will appreciate that FDA processing may involve briefly queuing the text messages for the delivery attempt. However, the text message is not persistently stored as is done for store-and-forward processing. If the first delivery attempt fails, then FDA system 134 may fallback to store-and-forward system 136 to deliver the text message. FDA system 134 may comprise a cluster of FDA processors that are operating to handle multiple text messages simultaneously. In one embodiment, the FDA processors in the cluster share a common network address, such as a common point code.

Store-and-forward system 136 comprises any system, server, application, or function that implements store-and-forward processing, one example of which is defined in SMS protocol. In store-and-forward processing, when a text message is initially received, the text message is persistently stored in memory. Delivery of the text message is then attempted to the destination. If the first delivery attempt is unsuccessful, then delivery is retried after a time period (e.g., 10 minutes, 30 minutes, etc). A predefined number of retries are performed before the text message is discarded.

Central database 138 comprises any storage system operable to store message indicators for subscribers of mobile network 100 that may be a destination of a text message. A message indicator indicates whether one or more prior text messages are pending in store-and-forward system 136 for a destination. In other words, if a text message intended for a destination is queued for delivery in store-and-forward system 136, then the message indicator indicates that the text message is queued in store-and-forward system 136. The message indicators are mapped to subscribers (i.e., destinations) in central database 138, and are updated based on information provided by store-and-forward system 136. Database 138 is considered “central” because it is accessible by message processor 132, FDA system 134, and store-and-forward system 136.

Although message processor 132, FDA system 134, store-and-forward system 136, and central database 138 are all shown as part of message system 124, those skilled in the art will appreciate that one or more of these systems may be implemented on different platforms within mobile network 100. For example, message processor 132 and FDA system 134 may be implemented in an SMS router, in a Signaling Transfer Point (STP), or some other network element, while store-and-forward system 136 may be implemented in an SMSC. Also, the functionality of message processor 132 may be performed in FDA system 134.

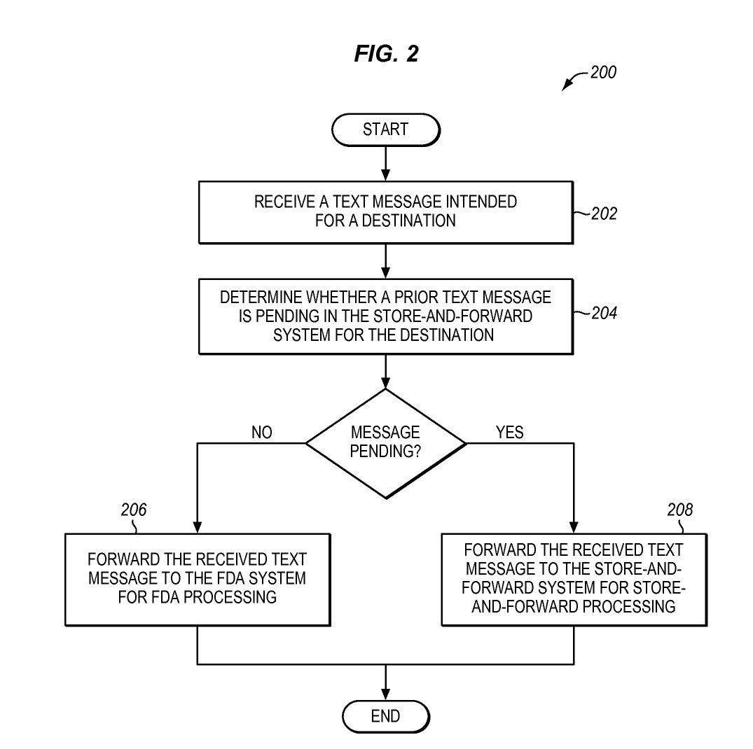

In FIG. 1, assume that sender 110 sends a text message to mobile network 100 that is intended for destination 112. Those skilled in the art will appreciate that the text message is encapsulated in a signaling message, such as an SS7 message or a SIP message. Instead of automatically applying FDA processing for the text message, message system 124 is able to determine whether to apply FDA processing or store-and-forward processing. A more detailed operation of message system 124 is illustrated in FIG. 2.

FIG. 2 is a flow chart illustrating a method 200 of controlling FDA processing and store-and-forward processing for text messages in an exemplary embodiment. The steps of method 200 will be described with reference to mobile network 100 in FIG. 1, but those skilled in the art will appreciate that method 200 may be performed in other networks and systems. The steps of the flow charts described herein are not all inclusive and may include other steps not shown. The steps may also be performed in an alternative order.

In step 202, message processor 132 receives the text message from sender 110 that is intended for destination 112. Instead of automatically forwarding the text message to FDA system 134 for FDA processing, message processor 132 determines whether a prior text message is pending in store-and-forward system 136 for destination 112 in step 204.

If a prior text message is not pending in store-and-forward system 136, then message processor 132 forwards the received text message to FDA system 134 for FDA processing. FDA system 134 will then attempt to deliver the text message to destination 112 first without persistently storing the text message. If the delivery attempt fails, then FDA system 134 may forward the text message to store-and-forward system 136 for store-and-forward processing.

If a prior text message is pending in store-and-forward system 136, then message processor 132 forwards the received text message to store-and-forward system 136 for store-and-forward processing. Store-and-forward system 136 will persistently store the received text message in memory, and then queue the received text message for delivery to destination 112. The received text message will be queued behind the prior text message in the order of delivery. For example, when receiving the prior text message, store-and-forward system 136 will queue the prior text message for delivery to destination 112. When receiving the received text message from message processor 132, store-and-forward system 136 will also queue the received text message for delivery to destination 112. The received text message will be queued behind the prior text message in the order of delivery, and thus will be delivered to destination 112 after the prior text message. Destination 112 will advantageously receive the text messages in the proper sequence.

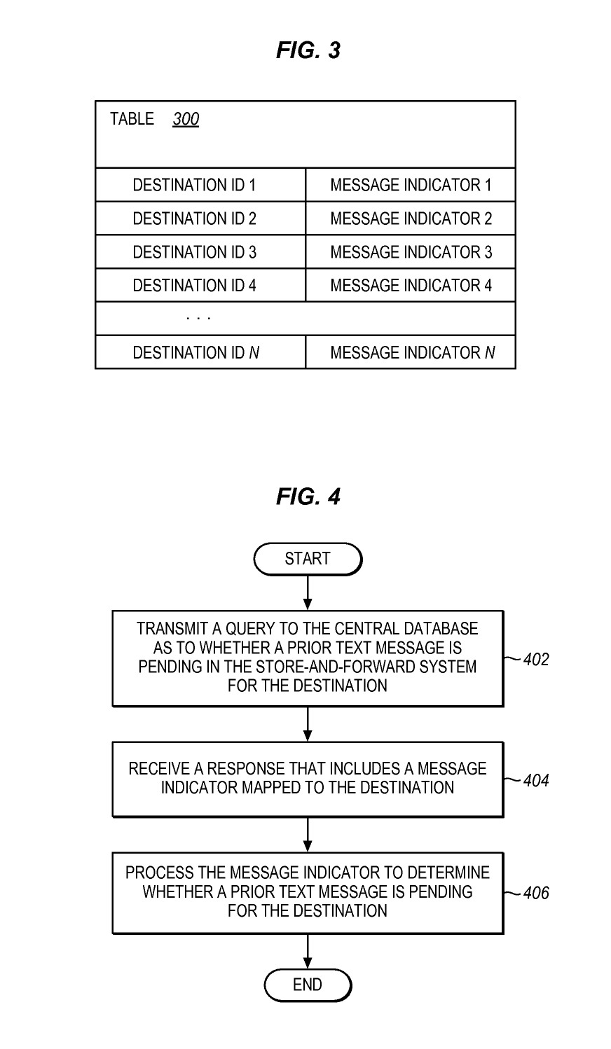

As described above, central database 138 (see FIG. 1) stores a message indicator for destination 112, and other subscribers of mobile network 100. FIG. 3 illustrates a table 300 that maps message indicators to destinations in an exemplary embodiment. In this embodiment, table 300 includes a plurality of destinations identifiers (ID) labeled as destination ID 1, destination ID 2, destination ID 3, destination ID 4, . . . , destination ID N. The destination ID may be a directory number, a network address, a network point code, an E.164 number, or some other identifier of the destination (or subscriber). Each of these destination IDs is mapped to or associated with a message indicator labeled as message indicator 1, message indicator 2, message indicator 3, message indicator 4, . . . , message indicator N. The message indicator may be a Boolean value, such as “0” or “1”, where a “0” indicates that no prior text message is pending and a “1” indicates that one or more prior text messages are pending. The message indicator may alternatively comprise a counter. If one text message is pending, then the counter is increased to “1”. If two text messages are pending, then the counter is increased to “2”. If no text messages are pending, then the counter is at “0”.

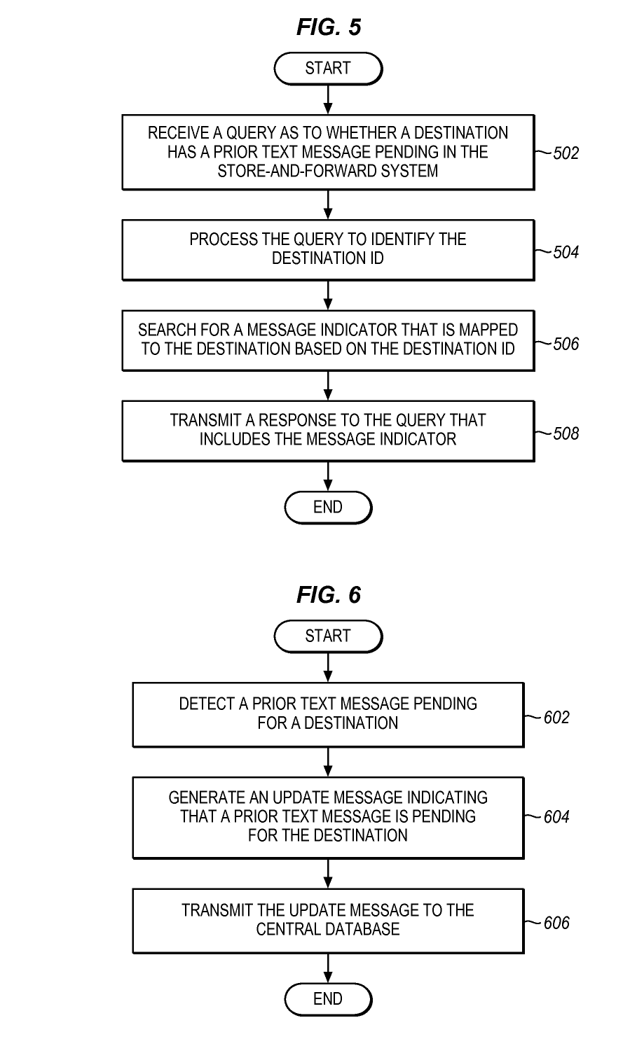

To determine whether a prior text message is pending in store-and-forward system 136 (see step 204 in FIG. 2), message processor 132 may query central database 138 for a message indicator that is mapped to destination 112, as is illustrated in FIGS. 4-5.

FIGS. 4-5 are flow charts illustrating a method of querying central database 138 for a message indicator in an exemplary embodiment. In FIG. 4, message processor 132 transmits a query to central database 138 in step 402 that includes a destination ID for destination 112. The query is sent in response to receiving the text message and before forwarding the text message to FDA system 134. The query requests information as to whether a prior text message is pending in store-and forward system 136 for destination 112. In other words, the query requests a message indicator that is mapped to destination 112, where the message indicator indicates whether a prior text message is pending in store- and forward system 136. The query may comprise an LDAP search request that includes a destination ID for destination 112, such as a directory number, a network address, etc.

In FIG. 5, central database 138 receives the query in step 502. In step 504, central database 138 processes the query to identify the destination ID for destination 112 that is included in the query. In step 506, central database 138 searches for a message indicator that is mapped to destination 112 based on the destination ID. Central database 138 then transmits a response to the query that includes the message indicator in step 508.

In FIG. 4, message processor 132 receives the response from central database 138 in step 404 that includes the message indicator mapped to destination 112. In step 406, message processor 132 processes the message indicator to determine whether a prior text message is pending in store-and-forward system 136 for destination 112.

Central database 138 in FIG. 1 is updated based on data provided by store-and-forward system 136. FIGS. 6-8 are flow charts illustrating a method of updating central database 138 in an exemplary embodiment. In FIG. 6, store-and-forward system 136 detects a prior text message pending for destination 112 in step 602. For example, each time that store-and-forward system 136 receives a text message and queues the text message for delivery, store-and-forward system 136 at this time may detect a “prior” text message. In step 604, store-and-forward system 136 generates an update message indicating that the prior text message is pending for destination 112. The update message includes a destination ID for destination 112. In step 606, store-and-forward system 136 transmits the update message to central database 138.

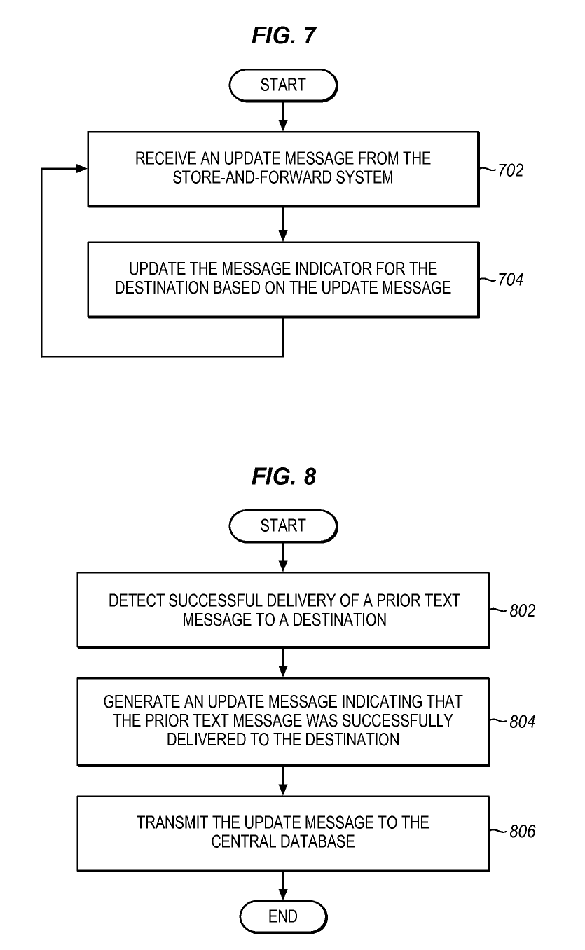

In FIG. 7, central database 138 receives the update message from store-and-forward system 136 in step 702. In step 704, central database 138 updates the message indicator for destination 112 based on the update message. For example, central database 138 may search table 300 (see FIG. 3) for the destination ID included in the update message. Central database 138 then identifies the message indicator that is mapped to the destination ID, and updates the message indicator based on the information included in the update message. If the message indicator comprises a Boolean value, then central database 138 may change the value from “0” to “1” to show that a prior text message is pending. If the message indicator comprises a counter, then central database 138 may increase the present value in the message indicator from “0” to “1”, “1” to “2”, “2” to “3”, etc, to show that an additional text message is pending for destination 112.

In FIG. 8, store-and-forward system 136 detects a successful delivery of a prior text message to destination 112 in step 802. For example, each time that store-and-forward system 136 attempts to deliver a text message and receives an acknowledgement, store-and-forward system 136 at this time may detect a successful delivery of a text message. Thus, store-and-forward system 136 detects that the prior text message was successfully delivered to destination 112 when an acknowledgement is received. In step 804, store-and-forward system 136 generates an update message indicating that the prior text message was successfully delivered to destination 112. In step 806, store-and-forward system 136 transmits the update message to central database 138.

In FIG. 7, central database 138 again receives the update message from store-and-forward system 136 in step 702. In step 704, central database 138 updates the message indicator for destination 112 based on the update message. For example, central database 138 may search table 300 (see FIG. 3) for the destination ID included in the update message. Central database 138 then identifies the message indicator that is mapped to the destination ID, and updates the message indicator based on the information included in the update message. If the message indicator comprises a Boolean value, then central database 138 may change the value from “1” to “0” to show that a prior text message is no longer pending. If the message indicator comprises a counter, then central database 138 may decrease the present value in the message indicator from “1” to “0”, “2” to “1”, “3” to “2”, etc (depending on the number of prior text messages that were/are pending for destination 112).

### Example

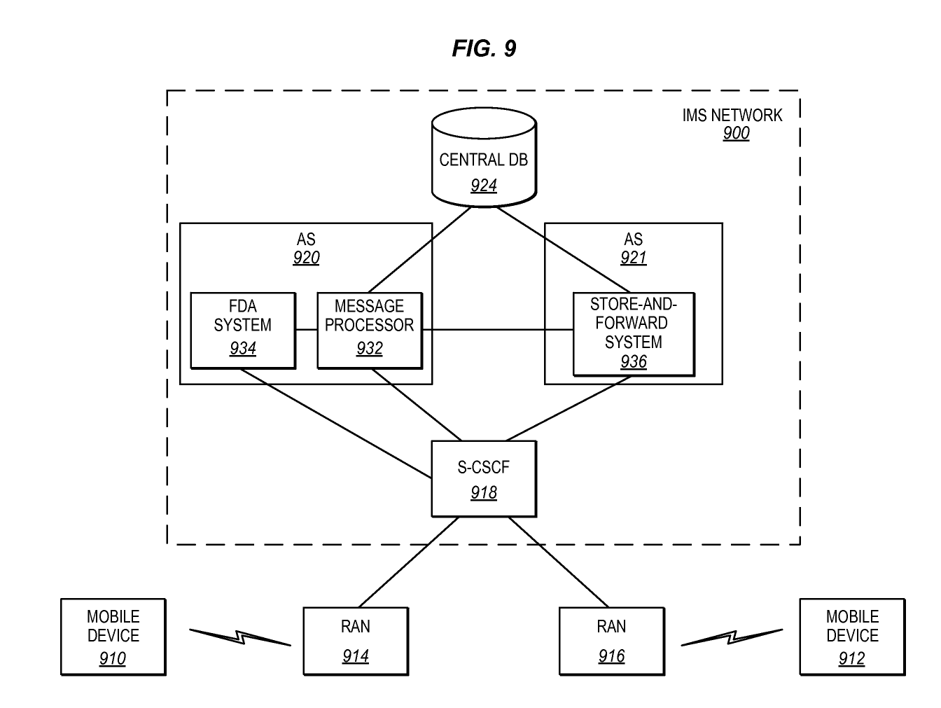

FIG. 9 illustrates an IMS network 900 in an exemplary embodiment. In this embodiment, IMS network 900 is operable to serve a mobile device 910 through a Radio Access Network (RAN) 914, which comprises any radio or wireless network that interfaces a mobile device with a core network. To serve mobile device 910, IMS network 900 includes a Serving-Call Session Control Function (S-CSCF) 918, application servers (AS) 920-921, and a central database 924. Application server 920 includes a message processor 932 and an FDA system 934. Message processor 932 is able to control whether FDA processing or store-and-forward processing is applied to an SMS message. FDA system 934 is able to deliver SMS messages to destinations using FDA processing, such as delivering an SMS message to mobile device 912 through RAN 916.

Application server 921 is operable to handle SMS messages, and therefore may be referred to as an SMSC. As part of handling SMS messages, application server 921 includes store-and-forward system 936 that uses SMS protocol. Store-and-forward system 936 is able to deliver SMS messages to destinations using store-and-forward processing, such as delivering an SMS message to mobile device 912 through RAN 916.

Central database 924 is able to store message indicators for subscribers of IMS network 900 that may be a destination of an SMS message. Similar to the prior embodiments, a message indicator indicates whether one or more prior SMS messages are pending in store-and-forward system 936. Central database 924 maintains a table that maps destinations to message indicators, one of which is illustrated in FIG. 3. Store-and-forward system 936 continually updates central database 924 as to which destinations have SMS messages pending.

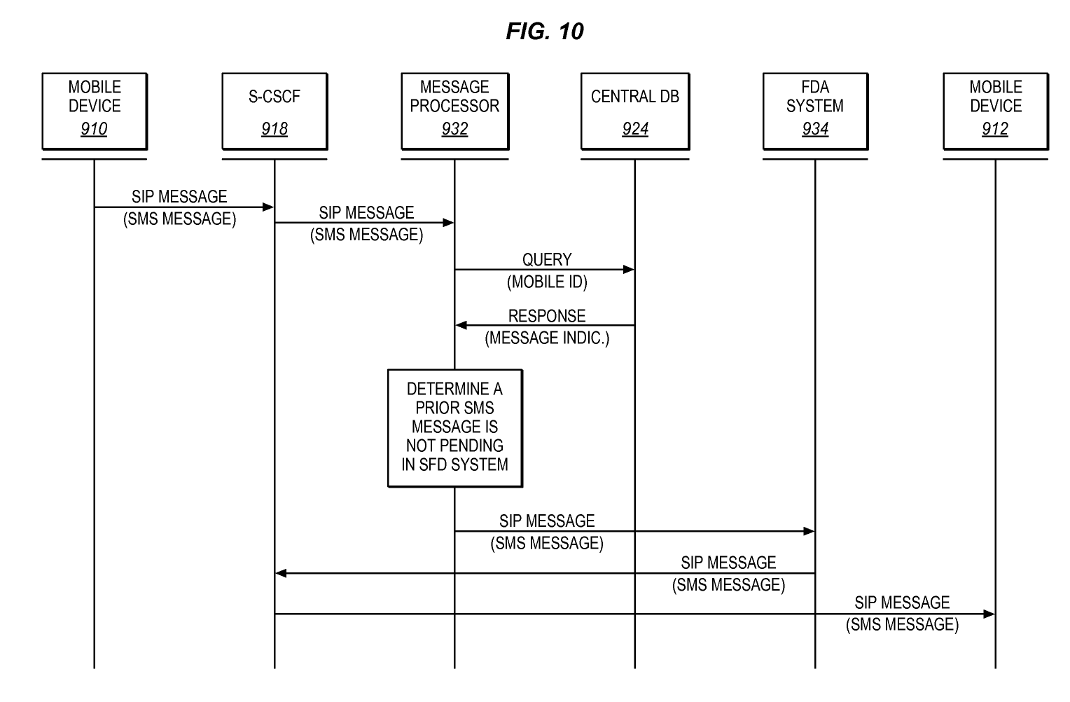

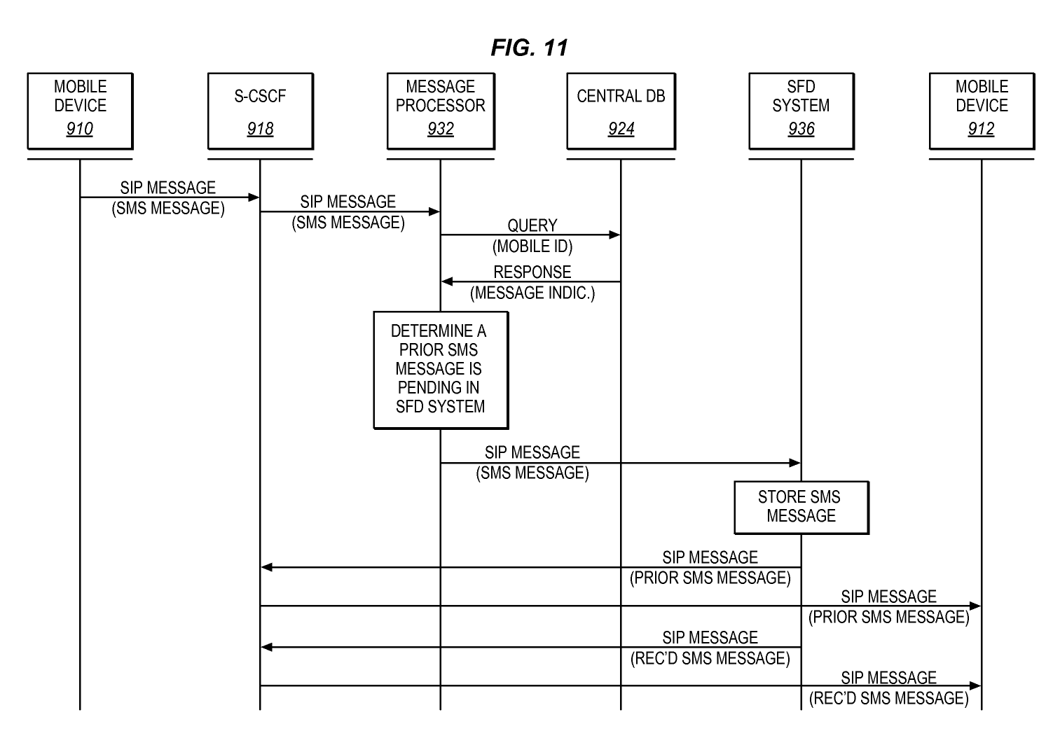

Assume for this example that a user of mobile device 910 initiates an SMS message to a user of mobile device 912. FIGS. 10-11 are message diagrams illustrating how message processor 932 ensures that the SMS message is delivered in the proper sequence in an exemplary embodiment. In FIG. 10, mobile device 910 encapsulates the SMS message in a SIP MESSAGE, and sends the SIP MESSAGE to S-CSCF 918. S-CSCF 918 processes the SIP MESSAGE and determines that it includes an SMS message. Thus, S-CSCF 918 forwards the SIP MESSAGE to application server 920. Message processor 932 in application server 920 receives the SIP MESSAGE that includes the SMS message. Instead of automatically forwarding the SMS message to FDA system 934 for FDA processing, message processor 932 determines whether a prior SMS message is pending in store-and-forward system 936 for mobile device 912 (the destination). To make this determination, message processor 932 transmits a query to central database 924 for a message indicator that is mapped to mobile device 912. The query includes a mobile ID for mobile device 912. Central database 924 receives and processes the query to identify the mobile ID for mobile device 912 that is included in the query. Central database 924 searches for a message indicator that is mapped to mobile device 912 based on the mobile ID, and transmits a response to the query that includes the message indicator.

Message processor 932 receives the response from central database 924, and processes the message indicator to determine whether a prior SMS message is pending in store-and-forward system 936 for mobile device 912. In this case, assume that a prior SMS message is not pending. Because no other SMS message is pending, there is no risk of the SMS messages being delivered out of sequence using FDA processing. Thus, message processor 932 forwards the SMS message to FDA system 934 for FDA processing by sending the SIP MESSAGE. In response to receiving the SMS message, FDA system 934 attempts to deliver the SMS message to its destination first without persistently storing the SMS message by sending the SIP MESSAGE to S-CSCF 918. S-CSCF 918 then sends the SIP MESSAGE to mobile device 912. If the delivery attempt fails, then FDA system 934 may forward the SMS message to application server 921 for store-and-forward processing.

In FIG. 11, the messages are the same as in FIG. 10 until message processor 932 determines whether a prior SMS message is pending in store-and-forward system 936 for mobile device 912. In this case, assume that one or more prior SMS messages are pending. Because other SMS messages are pending, there is a risk of the SMS messages being delivered out of sequence using FDA processing. Thus, message processor 932 forwards the SMS message to store-and-forward (SFD) system 936 for store-and-forward processing by sending the SIP MESSAGE. In response to receiving the SMS message, store-and-forward system 936 persistently stores the SMS message in memory, and queues the received SMS message for delivery to mobile device 912. The received SMS message will be queued behind the prior SMS message in the order of delivery. For example, when receiving the prior SMS message, store-and-forward system 936 will queue the prior SMS message for delivery to mobile device 912. When receiving the received SMS message from message processor 932, store-and-forward system 936 will also queue the received SMS message for delivery to mobile device 912. The received SMS message will be queued behind the prior SMS message in the order of delivery, and thus will be delivered to mobile device 912 after the prior SMS message.

Based on the order that the SMS messages are queued, store-and-forward system 936 attempts to deliver the prior SMS message by sending the SIP MESSAGE to S-CSCF 918. S-CSCF 918 then sends the SIP MESSAGE to mobile device 912. At a later time, store-and-forward system 936 attempts to deliver the received SMS message by sending another SIP MESSAGE to mobile device 912 (through S-CSCF 918 and RAN 916 in FIG. 9). Mobile device 912 will advantageously receive the SMS messages in the proper sequence.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A message system for a mobile network, the message system comprising:
a message processor operable to receive a text message intended for a destination, to determine whether a prior text message is pending in a store-and-forward system for the destination, to forward the received text message to a First Delivery Attempt (FDA) system for FDA processing responsive to a determination that a prior text message is not pending in the store-and-forward system, and to forward the received text message to the store-and-forward system for store-and-forward processing responsive to a determination that the prior text message is pending in the store-and-forward system.

2. The message system of claim 1 further comprising:
a central database operable to store message indicators for a plurality of destinations, wherein each message indicator indicates whether a prior text message is pending in the store-and-forward system for a destination.

3. The message system of claim 2 wherein:
the message processor is further operable to transmit a query to the central database as to whether a prior text message is pending in the store-and-forward system for the destination;
the central database is further operable to receive the query, to process the query to identify a destination identifier for the destination, to search for a message indicator that is mapped to the destination based on the destination identifier, and to transmit a response that includes the message indicator mapped to the destination; and
the message processor is further operable to receive the response that includes the message indicator for the destination, and to process the message indicator to determine whether a prior text message is pending in the store-and-forward system for the destination.

4. The message system of claim 2 further comprising:
the store-and-forward system operable to detect the prior text message pending for the destination, to generate a first update message indicating that the prior text message is pending for the destination, and to transmit the first update message to the central database.

5. The message system of claim 4 wherein:
the central database is further operable to receive the first update message from the store-and-forward system, and to update the message indicator for the destination based on the first update message.

6. The message system of claim 5 wherein:
the store-and-forward system is further operable to detect a successful delivery of the prior text message to the destination, to generate a second update message indicating that the prior text message was successfully delivered to the destination, and to transmit the second update message to the central database.

7. The message system of claim 6 wherein:
the central database is further operable to receive the second update message from the store-and-forward system, and to update the message indicator for the destination based on the second update message.

8. A method within a mobile network, the method comprising:
receiving a text message intended for a destination;
determining whether a prior text message is pending in a store-and-forward system for the destination;
forwarding the received text message to a First Delivery Attempt (FDA) system for FDA processing responsive to a determination that a prior text message is not pending in the store-and-forward system; and
forwarding the received text message to the store-and-forward system for store-and-forward processing responsive to a determination that the prior text message is pending in the store-and-forward system.

9. The method of claim 8 further comprising:
storing message indicators in a central database for a plurality of destinations, wherein each message indicator indicates whether a prior text message is pending in the store-and-forward system for a destination.

10. The method of claim 9 further comprising:
transmitting a query to the central database as to whether a prior text message is pending in the store-and-forward system for the destination;
receiving a response that includes a message indicator for the destination; and
processing the message indicator in the response to determine whether a prior text message is pending in the store-and-forward system for the destination.

11. The method of claim 10 further comprising:
receiving the query in the central database;
processing the query to identify a destination identifier for the destination;
searching for the message indicator that is mapped to the destination based on the destination identifier; and
transmitting the response that includes the message indicator mapped to the destination.

12. The method of claim 9 further comprising:
detecting the prior text message in the store-and-forward system pending for the destination;
generating a first update message indicating that the prior text message is pending for the destination; and
transmitting the first update message from the store-and-forward system to the central database.

13. The method of claim 12 further comprising:
receiving the first update message in the central database from the store-and-forward system; and
updating the message indicator for the destination based on the first update message.

14. The method of claim 13 further comprising:
detecting a successful delivery of the prior text message to the destination in the store-and-forward system;
generating a second update message indicating that the prior text message was successfully delivered to the destination; and
transmitting the second update message from the store-and-forward system to the central database.

15. The method of claim 14 further comprising:
receiving the second update message in the central database from the store-and-forward system; and
updating the message indicator for the destination based on the second update message.

16. A mobile network comprising:
a First Delivery Attempt (FDA) system operable to implement FDA processing, wherein FDA processing comprises attempting delivery of text messages first before storing the text messages;
a store-and-forward system operable to implement store-and-forward processing, wherein store-and-forward processing comprises storing text messages first and then attempting delivery of text messages; and
a message processor operable to receive a text message intended for a destination, to determine whether a prior text message is pending in the store-and-forward system for the destination, to forward the received text message to the FDA system for FDA processing responsive to a determination that the prior text message is not pending in the store-and-forward system, and to forward the received text message to the store-and-forward system for store-and-forward processing responsive to a determination that the prior text message is pending in the store-and-forward system so that the prior text message and the received text message are delivered in sequence.

17. The mobile network of claim 16 further comprising:
a central database operable to store message indicators for a plurality of destinations, wherein each message indicator indicates whether a prior text message is pending in the store-and-forward system for a destination;
wherein the message processor is further operable to transmit a query to the central database as to whether a prior text message is pending in the store-and-forward system for the destination;
wherein the central database is further operable to receive the query, to process the query to identify a destination identifier for the destination, to search for a message indicator that is mapped to the destination, and to transmit a response to the query that includes the message indicator mapped to the destination;
wherein the message processor is further operable to receive the response that includes the message indicator for the destination, and to process the message indicator in the response to determine whether a prior text message is pending in the store-and-forward system for the destination.

18. The mobile network of claim 17 wherein:
the store-and-forward system is further operable to detect the prior text message pending for the destination, to generate a first update message indicating that the prior text message is pending for the destination, and to transmit the first update message to the central database; and
the central database is further operable to receive the first update message from the store-and-forward system, and to update the message indicator for the destination based on the first update message.

19. The mobile network of claim 18 wherein:
the store-and-forward system is further operable to detect a successful delivery of the prior text message to the destination, to generate a second update message indicating that the prior text message was successfully delivered to the destination, and to transmit the second update message to the central database; and
the central database is further operable to receive the second update message from the store-and-forward system, and to update the message indicator for the destination based on the second update message.

20. The mobile network of claim 16 wherein the FDA system comprises a cluster of FDA processors sharing a common network address.
